(19) United States
(12) Patent Application Publication
(10) Pub. No.: US 2021/0121763 A1
(43) Pub. Date: Apr. 29, 2021

(54) EMBELLISHMENTS FOR SPORTS OR RECREATIONAL EQUIPMENT

(71) Applicant: Amy Kathleen Lutz, Cincinnati, OH (US)

(72) Inventor: Amy Kathleen Lutz, Cincinnati, OH (US)

(21) Appl. No.: 17/084,148

(22) Filed: Oct. 29, 2020

Related U.S. Application Data
(60) Provisional application No. 62/927,435, filed on Oct. 29, 2019.

(51) Int. Cl. A63B 71/06; A63B 67/06; A63B 67/04; A63F 7/00; A63B 63/08; A63B 59/42

(52) U.S. Cl. CPC A63B 71/0619; A63B 67/06; A63B 67/04; A63B 2071/0694; A63B 63/083; A63B 59/42; A63B 2209/10; A63F 7/0005

(57) ABSTRACT

An exemplary embellishment is configured for use with sports or recreational equipment having a flat/planar surface. The embellishment is in the form of a planar sheet including a front surface and a rear surface opposite the front surface. The planar sheet is sized and shaped to correspond to a size and shape of the planar surface of the equipment. The front surface comprises at least one ornamental marking and/or at least one functional marking. Each functional marking relates to performance of a sport or recreational activity corresponding to the equipment. The rear surface has disposed thereon an adhesive configured to removably secure the planar sheet to the planar surface.

### CROSS-REFERENCE TO RELATED APPLICATIONS

The present application claims the benefit of U.S. Provisional Application No. 62/927,435 filed Oct. 29, 2019, the contents of which are incorporated herein by reference in their entirety.

### TECHNICAL FIELD

This application generally relates to ornamental attachments or embellishments for sports or recreational equipment.

### BACKGROUND

Certain types of sports and recreational equipment include flat/planar surfaces such as, for example, the backboards of basketball goals, the striking surfaces of pickleball and table tennis paddles, and the playing surfaces of cornhole boards, table tennis tables, foosball tables, and shuffleboard tables. While these surfaces are occasionally provided with markings related to aspects of the sport (such as boundary lines, targets, or other markings), the majority of the surface is typically left unadorned. Conventional methods of adorning these surfaces are typically permanent, including adornments applied via painting or printing. However, it may be desirable in certain circumstances to provide for removable adornments. For this reason, among others, there remains a need for further improvements in this technological field.

### SUMMARY

An exemplary embellishment is configured for use with sports or recreational equipment having a flat/planar surface. The embellishment includes a planar sheet having a front surface and a rear surface opposite the front surface. The planar sheet is sized and shaped to correspond to a size and shape of the flat/planar surface of the sports equipment. The front surface includes at least one ornamental and/or functional marking. The functional marking(s) relates to performance of a sport or recreational activity corresponding to the sports or recreational equipment. The rear surface has disposed thereon an adhesive configured to removably secure the planar sheet to the flat/planar surface of the equipment. Further embodiments, forms, features, and aspects of the present application shall become apparent from the description and figures provided herewith.

### BRIEF DESCRIPTION OF THE FIGURES

FIG. 1A is a front-side perspective view of an embellishment according to certain embodiments.

FIG. 1B is a rear-side perspective view of the embellishment illustrated in FIG. 1A.

FIG. 2 is a plan view of a basketball goal and the embellishment illustrated in FIGS. 1A and 1B.

FIG. 3 is a perspective illustration of a cornhole board and an embellishment configured for use with the same.

FIG. 4 is a perspective illustration of a table tennis table and an embellishment configured for use with the same.

FIG. 5 is a plan view of several pickleball paddles and embellishments configured for use with the same.

FIG. 6 is a perspective view of a shuffleboard table and an embellishment configured for use with the same.

FIG. 7 is a perspective illustration of a table tennis paddle and an embellishment configured for use with the same.

FIG. 8 is a schematic flow diagram of a process according to certain embodiments.

FIG. 9 is a plan view of an example of a first embellishment configured for use with a cornhole board.

FIG. 10 is a plan view of an example of a second embellishment configured for use with a cornhole board.

### DETAILED DESCRIPTION OF ILLUSTRATIVE EMBODIMENTS

Although the concepts of the present disclosure are susceptible to various modifications and alternative forms, specific embodiments have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. It should further be appreciated that although reference to a “preferred” component or feature may indicate the desirability of a particular component or feature with respect to an embodiment, the disclosure is not so limiting with respect to other embodiments, which may omit such a component or feature. Further, when a particular feature, structure, or characteristic is described in connection with an embodiment, it is submitted that it is within the knowledge of one skilled in the art to implement such feature, structure, or characteristic in connection with other embodiments whether or not explicitly described.

Additionally, it should be appreciated that items included in a list in the form of “at least one of A, B, and C” can mean (A); (B); (C); (A and B); (B and C); (A and C); or (A, B, and C). Similarly, items listed in the form of “at least one of A, B, or C” can mean (A); (B); (C); (A and B); (B and C); (A and C); or (A, B, and C). Items listed in the form of “A, B, and/or C” can also mean (A); (B); (C); (A and B); (B and C); (A and C); or (A, B, and C). Further, with respect to the claims, the use of words and phrases such as “a,” “an,” “at least one,” and/or “at least one portion” should not be interpreted so as to be limiting to only one such element unless specifically stated to the contrary, and the use of phrases such as “at least a portion” and/or “a portion” should be interpreted as encompassing both embodiments including only a portion of such element and embodiments including the entirety of such element unless specifically stated to the contrary.

In the drawings, some structural or method features may be shown in certain specific arrangements and/or orderings. However, it should be appreciated that such specific arrangements and/or orderings may not necessarily be required in all embodiments. Rather, in some embodiments, such features may be arranged in a different manner and/or order than shown in the illustrative figures unless indicated to the contrary. Additionally, inclusion of a structural or method feature in a particular figure is not meant to imply that such feature is required in all embodiments and, in some embodiments, may be omitted or may be combined with other features.

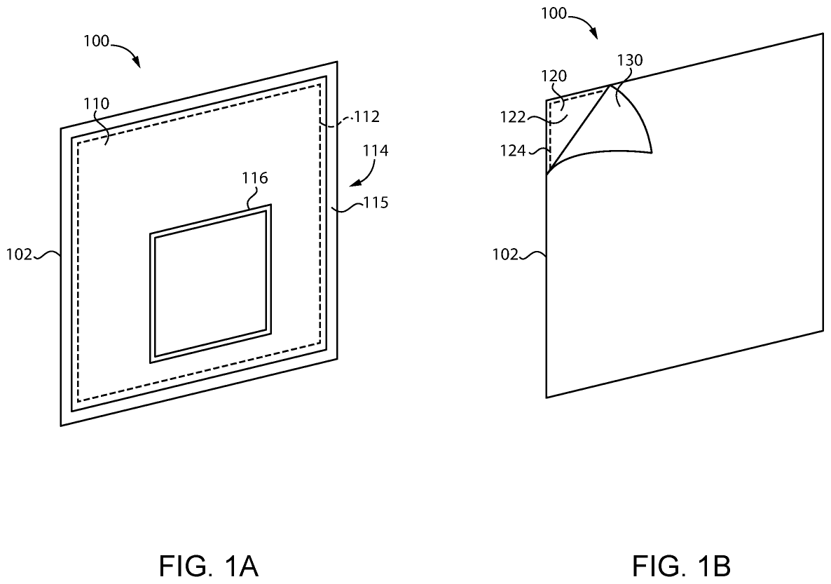

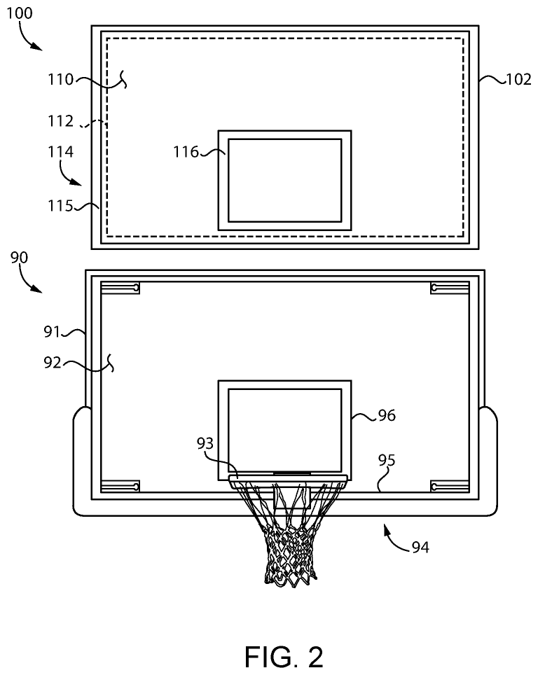

With reference to FIGS. 1 and 2, illustrated therein is a removable embellishment 100 configured for use with sporting equipment that includes a planar surface to which the embellishment 100 may be adhered. More particularly, while other embodiments are described herein, the embellishment 100 illustrated in FIGS. 1 and 2 is configured for use with a basketball goal 90. The basketball goal 90 includes a backboard 91 defining a planar surface 92, and a hoop 93 projecting from the backboard 91. Provided on the backboard 91 are functional markings 94 in the form of a boundary line 95 and a target box 96.

The embellishment 100 is provided in the form of a planar sheet 102 including a front surface 110 and a rear surface 120, and a protective film 130 is removably adhered to the rear surface 120. In certain embodiments, the planar sheet 102 may be formed of clear, translucent, or opaque vinyl, while in other embodiments, the sheet 102 may be formed of another type of clear, translucent, or opaque material. While other embodiments are contemplated, the illustrated embellishment 100 is configured to be mounted to a planar substrate defined by the backboard 91, and has a size and shape corresponding to that of the backboard 91 with which the embellishment is configured for use. As described herein, other embodiments of embellishments may be configured for use with other types of sports and recreational equipment.

The front surface 110 includes ornamental markings 112, and may further include functional markings 114. The ornamental markings 112 may, for example, include one or more of a color, a logo, a design, an emblem, a seal, a pattern, a word, a symbol, a photograph, or another form of ornamental marking. In certain embodiments, the ornamental markings 112 may be purely aesthetic such as, for example, in the case of colors and/or patterns. As described herein, the ornamental markings 112 may additionally or alternatively convey information to the user such as, for example, in the case of logos, emblems, text, and symbols. When present, the functional markings may relate to the particular sport corresponding to the equipment for which the embellishment 100 is configured for use. For example, the illustrated embellishment 100 is configured to be applied to the backboard 91 of a basketball goal 90, and includes functional markings 114 in the form of a boundary line 115 and a target box 116 corresponding to the boundary line 95 and target box 96.

The rear surface 120 includes and/or is coated with an adhesive 122, and may further include additional ornamental markings 124. In certain embodiments, the adhesive 122 may be provided as a relatively heavy or strong adhesive configured to facilitate attachment of the embellishment 100 to a substrate. In other embodiments, the adhesive 122 may be provided as a relatively light or weak adhesive configured to facilitate removable attachment of the embellishment 100 to the substrate. The additional markings 124 may be the same as, similar to, or different from the first ornamental markings 112, and may be provided in embodiments in which the substrate is defined by a transparent or translucent pane of material, such as the clear backboard 91 illustrated in FIG. 2. In this manner, the embellishment 100 may increase the aesthetic appeal of the sports equipment and/or provide information to viewers at additional angles (e.g., to spectators in the audience).

The protective film 130 is adhered to the rear surface 120 by the adhesive 122, and protects the adhesive 122 from collecting debris until such time as the user is prepared to install the embellishment 100 to the substrate or planar surface 92. At that point, the user may remove the film 130 to expose the adhesive 122, and subsequently install the embellishment 100 to the equipment 90 by applying and adhering the rear surface 120 to the planar surface 92.

In the illustrated form, the adhesive 122 is provided as a relatively weak adhesive that removably secures the embellishment 100 to the planar surface 92. Thus, when it is no longer desired for the embellishment 100 to be attached to the equipment 90, the embellishment 100 may be removed from the planar surface 92 without damaging the planar surface 92 or leaving a residue on the planar surface 92. As noted above, in certain embodiments, the sheet 102 may be formed of vinyl. One example of a suitable adhesive vinyl sheet is 4 mm white flexible vinyl with a low peel/repositionable adhesive, which is commercially available from GPA Specialty Substrate Solutions.

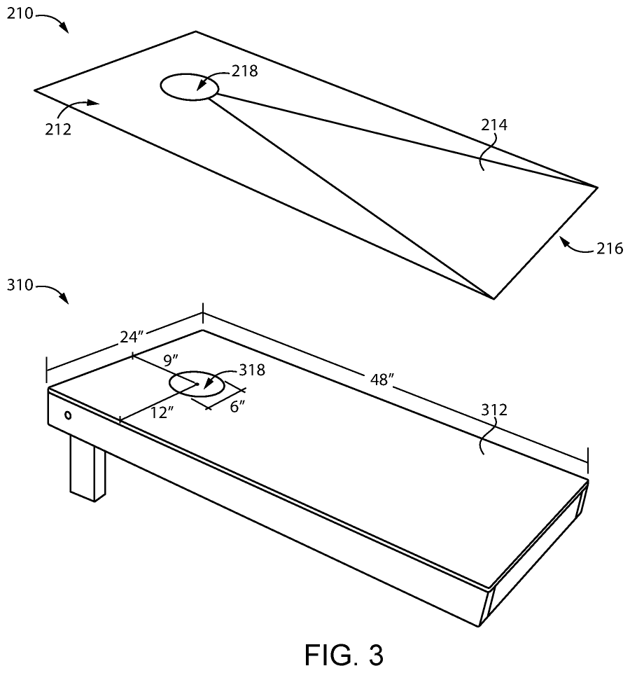

With additional reference to FIG. 3, illustrated therein is an embellishment 210 configured for use with sports or recreational equipment in the form of a cornhole board 310. The embellishment 210 is an alternative embodiment of the above-described embellishment 100, and is sized and shaped for use with the cornhole board 310. The cornhole board 310 may have the standard dimensions represented in FIG. 3, or may have other dimensions. The cornhole board 310 includes a flat/planar playing surface 312 having a hole 318 formed therein.

The embellishment 210 has dimensions corresponding to those of the cornhole board 310 such that the embellishment 210 covers substantially all of the flat/planar playing surface 312 when applied to the cornhole board 310. The embellishment 210 includes ornamental markings 212, and may further include functional markings 214. The markings 212, 214 are provided on a front surface of the embellishment 210, and the opposite rear surface of the embellishment 210 includes an adhesive corresponding to the adhesive 120. In the illustrated embodiment, the ornamental markings 212 are provided in the form of a first color, and the functional markings 214 are provided in the form of a second color. More particularly, the functional markings 214 are provided in the form of a trapezoid or triangle that tapers from a first width at or near the proximal end 216 of the embellishment 210 to a lesser second width at or near a hole 218 corresponding to the hole 318. The functional markings 214 may provide the user with a target zone or guide to aim their throws. In certain embodiments, the hole 218 may be formed in the embellishment 210 at the time of sale, while in other embodiments the hole 218 may be cut by the user during the installation process.

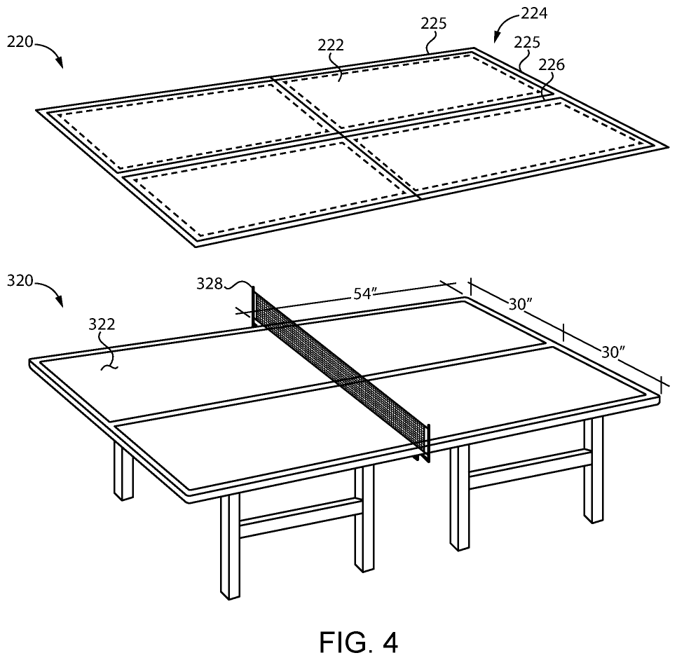

With additional reference to FIG. 4, illustrated therein is an embellishment 220 configured for use with sports or recreational equipment in the form of a table tennis table 320. The embellishment 220 is an alternative embodiment of the above-described embellishment 100, and is sized and shaped for use with the table tennis table 320. The table tennis table 320 may have the standard dimensions represented in FIG. 4, or may have other dimensions. The table tennis table 320 includes a planar playing surface 322, which is typically divided into two segments on opposite sides of a net 328. Accordingly, the embellishment 220 may be divided into a corresponding pair of segments, each configured for installation to a corresponding segment of the planar playing surface 322.

The embellishment 220 has dimensions corresponding to those of the table 320 such that the embellishment 220 covers substantially all of the planar playing surface 322 when applied to the table 320. The embellishment 220 includes ornamental markings 222, and may further include functional markings 224. The markings 222, 224 are provided on a front surface of the embellishment 220, and the opposite rear surface of the embellishment 220 includes an adhesive corresponding to the adhesive 120. In the illustrated embodiment, the ornamental markings 222 are provided in the form of a first color, and the functional markings 224 are provided in the form of a second color. It is also contemplated that the ornamental markings 222 may be provided in another form, such as one including logos, images, drawings, symbols, text, or other ornamental markings. The functional markings 224 are provided in the form boundary lines including sidelines 225 and a centerline 226, which may be used during table tennis play.

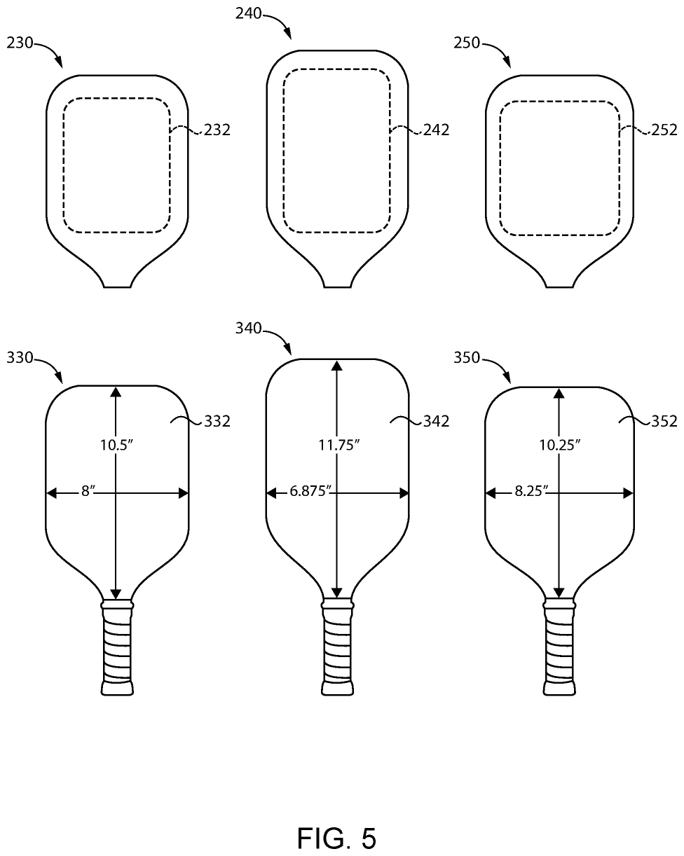

With additional reference to FIG. 5, illustrated therein are embellishments 230, 240, 250 configured for use with sports or recreational equipment in the form of pickleball paddles 330, 340, 350. The embellishments 230, 240, 250 are alternative embodiments of the above-described embellishment 100, and are sized and shaped for use with the pickleball paddles 330, 340, 350. The pickleball paddles 330, 340, 350 may have the standard dimensions represented in FIG. 5, or may have other dimensions. Each pickleball paddle 330, 340, 350 includes a corresponding and respective pair of planar striking surface 332, 342, 352 to which the appropriate one of the embellishments 230, 240, 250 may be applied. While one instance of each embellishment 230, 240, 250 is illustrated in FIG. 5, it is to be appreciated that the striking surface that is obscured from view in FIG. 5 may have a second instance of an embellishment 230, 240, 250 mounted thereon.

Each embellishment 230, 240, 250 has dimensions corresponding to those of the respective paddle 330, 340, 350 such that each embellishment 220 covers substantially all of the planar striking surface 332, 342, 352 when applied to the corresponding paddle 330, 340, 350. Each embellishment 230, 240, 250 includes a corresponding and respective set of ornamental markings 232, 242, 252, such as colors, logos, patterns, or other ornamental markings. The markings 232, 242, 252 are provided on front surfaces of the embellishments 230, 240, 250, and the opposite rear surfaces of the embellishments 230, 240, 250 include adhesive corresponding to the adhesive 120.

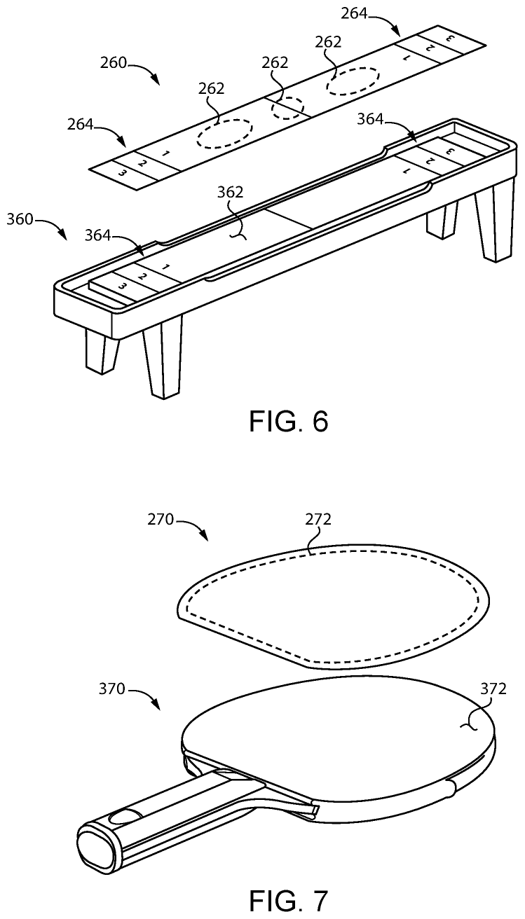

With additional reference to FIG. 6, illustrated therein is an embellishment 260 configured for use with sports or recreational equipment in the form of a shuffleboard table 360. The embellishment 260 is an alternative embodiment of the above-described embellishment 100, and is sized and shaped for use with the shuffleboard table 360. The shuffleboard table 360 includes a planar playing surface 362 to which such an embellishment 260 may be mounted. The embellishment 260 has dimensions corresponding to those of the playing surface 362 such that the embellishment 260 covers substantially all of the planar playing surface 362 when applied to the table 360. The embellishment 260 may include ornamental markings 262 such as one or more of a color, a logo, a design, an emblem, a seal, a pattern, a word, a symbol, a photograph, or another form of ornamental marking. The playing surfaces 362 of shuffleboard tables 360 typically have various point-related zones 364 defined thereon. Accordingly, the embellishment 260 may further include functional markings 264 in the form of target areas identifying the point-related zones. The markings 262, 264 are provided on a front surface of the embellishment 260, and the opposite rear surface of the embellishment 260 includes an adhesive corresponding to the adhesive 120.

With additional reference to FIG. 7, illustrated therein is an embellishment 270 configured for use with sports or recreational equipment in the form of a table tennis paddle 370. The embellishment 270 is an alternative embodiment of the above-described embellishment 100, and is sized and shaped for use with the table tennis paddle 370. The table tennis paddle 370 includes a planar striking surface 372 to which the embellishment 270 may be mounted. The embellishment 270 has dimensions corresponding to those of the paddle 370 such that the embellishment 270 covers substantially all of the planar striking surface 372 when applied to the paddle 370. The embellishment 220 may include ornamental markings 272 such as one or more of a color, a logo, a design, an emblem, a seal, a pattern, a word, a symbol, a photograph, or another form of ornamental marking. The markings 272 are provided on a front surface of the embellishment 270, and the opposite rear surface of the embellishment 270 includes an adhesive corresponding to the adhesive 120. While one embellishment 270 is illustrated in FIG. 7, it is to be appreciated that the striking surface that is obscured from view in FIG. 7 may have a second instance of the embellishment 270 mounted thereon.

While certain illustrative forms of embellishments and equipment have been described with reference to FIGS. 1-7, it is to be appreciated that embellishments according to other embodiments may be configured for use with other forms of sports or recreational equipment that define planar surfaces. As one example, an embellishment according to certain embodiments may be configured for use with equipment in the form of a foosball table, which includes a flat/planar playing surface to which the embellishment may be mounted. The playing surfaces of foosball tables typically have lines corresponding to those of a soccer field, which may be used during foosball play. An embellishment for a foosball table may include ornamental markings such as one or more of a color, a logo, a design, an emblem, a seal, a pattern, a word, a symbol, a photograph, or another form of ornamental marking. Such an embellishment may further include functional markings corresponding to the lines typically provided to foosball tables.

In certain embodiments described hereinabove, the embellishment is configured to cover all or substantially all (e.g., at least 98%) of the planar surface to which it is applied. It is also contemplated that an embellishment may cover less than all of the planar surface to which it is applied. For example, certain embodiments may be configured to cover at least 75% of the planar surface, while other embodiments may be configured to cover at least 90% of the planar surface. It is also contemplated that an embellishment may simply cover a majority of the planar surface.

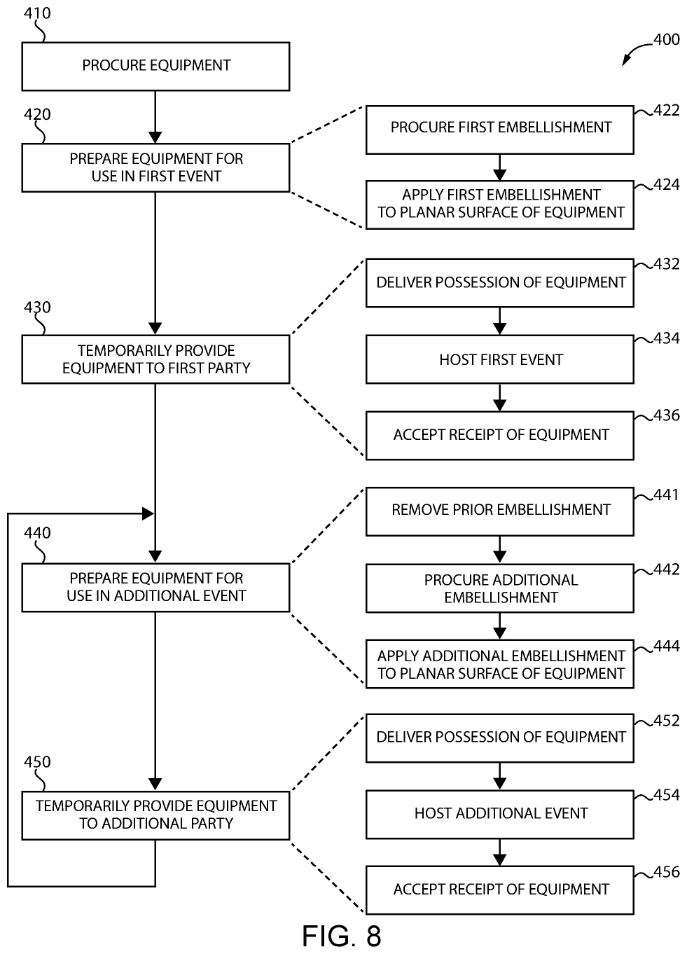

With additional reference to FIG. 8, illustrated therein is an example process 400 according to certain embodiments. Blocks illustrated for the processes in the present application are understood to be examples only, and blocks may be combined or divided, and added or removed, as well as re-ordered in whole or in part, unless explicitly stated to the contrary. Unless specified to the contrary, it is contemplated that certain blocks performed in the process 400 may be performed wholly by a single party, or that the blocks may be distributed among two or more parties. Additionally, while the blocks are illustrated in a relatively serial fashion, it is to be understood that two or more of the blocks may be performed concurrently or in parallel with one another.

The process 400 generally relates to a method of utilizing embellishments in combination with sports or recreational equipment. The following description of the process 400 will first involve a general description of the process 400, followed by an exemplary use case associated with the process 400. Additionally, while the process 400 is initially described with specific reference to the embellishment 100 illustrated in FIGS. 1 and 2, those skilled in the art would readily appreciate that similar steps and operations may be performed with embellishments of other types, such as those illustrated in FIGS. 3-7 and other not specifically illustrated in the figures.

The process 400 may begin with block 410, which generally involves procuring sports or recreational equipment that may be utilized in at least one sports or recreational event. As used herein, the term procuring encompasses constructing, fabricating, renting, leasing, reserving, borrowing, buying, or otherwise obtaining actual or constructive possession of the equipment, whether that possession be temporary or permanent. By way of example, block 410 may involve renting or purchasing a portable basketball goal 90, or a reserving a basketball court including a permanently installed basketball goal 90. As noted above, a basketball goal 90 typically includes a backboard 91 defining a planar surface 92 that is suitable for use in the process 400. In certain embodiments, block 410 may be omitted, for example in the event that the party performing the process 400 has already procured the sports or recreational equipment prior to beginning the process 400.

The process 400 includes block 420, which generally involves preparing the sports or recreational equipment for use in a first event. The first event may, for example, be one or more of a corporate event, a team-building event, a tournament, a charity event, a school-related event, a fundraiser, or another type of event that involves a sports or recreational activity that utilizes the sports or recreational equipment procured in block 410 or previously procured by the one or more parties performing the process 400.

Block 420 generally involves block 422, which involves procuring a first embellishment configured to be mounted to the planar surface of the equipment. For example, in the event that the equipment procured in block 410 includes a basketball goal 90, block 422 may involve procuring an embellishment configured to cover the backboard 91 of the basketball goal 90, such as the embellishment 100 illustrated in FIGS. 1 and 2. As another example, should the equipment procured in block 410 include a cornhole board 310, block 422 may involve procuring an embellishment 210 configured to cover the playing surface 312 of the cornhole board 310. Those skilled in the art will readily recognize that other forms of embellishment may be procured should the equipment take another form, including but not limited to those described above.

The first embellishment procured in block 422 comprises a first set of ornamental markings that relate to the first event, and which may convey to viewers information relating to the first event. The ornamental markings of the first embellishment may, for example, include one or more of a color, a logo, a design, an emblem, a seal, a pattern, a word, a symbol, a photograph, or another form of ornamental marking. In certain embodiments, the first set of ornamental markings may convey to viewers information relating to the sport or recreational activity that will be performed using the equipment, the date and/or time of the first event, and/or the name of the first event. In certain embodiments, the first set of ornamental markings may convey to viewers information relating to the host of the first event, a sponsor of the first event, a beneficiary of the first event, and/or a participant in the first event. The first embellishment procured in block 422 may further comprise a first set of functional markings, such as the boundary lines and/or target zones described above.

Block 420 further includes block 424, which generally involves removably adhering the first embellishment to the planar surface of the equipment. Block 424 may, for example, involve removing the protective film 130 from the rear surface 120 of the embellishment 100 and adhering the rear surface 120 to the planar surface 92 defined by the backboard 91 of the basketball goal 90. When so applied, the first embellishment 100 may cover a majority of the planar surface 92, at least 75% of the planar surface, at least 90% of the planar surface, substantially all of the planar surface (e.g., at least 98%), or an entirety of the planar surface. In certain embodiments, block 424 involves applying the rear surface 120 to the planar substrate without applying an additional adhesive medium (e.g., water, glue, or another adhesive medium) to either of the rear surface 120 or the planar substrate.

The process 400 further includes block 430, which generally involves providing the equipment with the first embellishment attached to a first party. The first party may, for example, be an organizer of the first event, a host of the first event, a participant in the first event, a sponsor of the first event, a beneficiary of the first event, or a party acting on behalf of the organizer, host, participant, sponsor, and/or beneficiary.

Block 430 may include block 432, which generally involves delivering constructive or actual possession of the equipment to the first party. For example, in the event that the equipment is portable (e.g., a portable basketball goal 90), block 432 may involve delivering the equipment to the locus of the first event or another designated area, causing the equipment to be delivered to the locus of the first event or another designated area, or allowing the equipment to be picked up by the first party. In the event that the equipment is a fixed structure (e.g., a permanently-installed basketball goal 90) or is maintained on a particular premises (e.g., an arena, park, community center, event center, or sports complex), block 432 may involve allowing participants of the first event to enter the premises containing the equipment at the scheduled time of the first event.

In certain embodiments, block 430 may involve block 434, which generally involves hosting the first event. For example, should the equipment be permanently installed to a premises that is in the possession of the party performing the process 400, such a party may host the first event or allow the first event to be hosted on the premises.

Block 430 further involves block 436, which generally involves accepting receipt of the equipment, for example after conclusion of the first event. For example, in the event that the equipment is portable (e.g., a portable basketball goal), block 436 may involve transporting the equipment from the locus of the event to a designated area (e.g., a warehouse or storage facility), causing the equipment to be transported from the locus of the event to the designated area, or receiving delivery of the equipment at the designated area from the first party or a third party acting on behalf of the first party. In the event that the equipment is a fixed structure or is maintained on a particular premises, block 436 may involve accepting constructive receipt of the equipment when the participants leave the premises and/or at the scheduled end of the first event.

The process 400 may further include block 440, which generally involves preparing the sports or recreational equipment for use in an additional event (e.g., a second event) subsequent to the first event. Like the first event, the second event may, for example, be one or more of a corporate event, a team-building event, a tournament, a charity event, a school-related event, a fundraiser, or another type of event that involves use of the sports or recreational equipment procured in block 410 or previously procured by the one or more parties performing the process 400.

Block 440 includes block 441, which generally involves removing the previously-installed embellishment from the planar surface of the equipment. Due to the fact that the adhesive 122 is relatively light, removing the previously-installed embellishment does not damage the planar surface (e.g., by peeling paint or decals off the planar surface). In certain embodiments, the adhesive 122 may be selected such that removal of the embellishment does not leave a residue on the flat/planar surface to which it is applied.

Block 440 further includes block 442, which involves procuring an additional embellishment (e.g., a second embellishment) configured to be mounted to the planar surface of the equipment. It should be appreciated that block 442 may be performed contemporaneously with block 422, for example in the event that the one or more parties performing the process 400 knows in advance the relevant details regarding the first and second events.

The second embellishment procured in block 442 comprises a second set of ornamental markings that relate to the second event, and which may convey to viewers information relating to the second event. The ornamental markings of the second embellishment may, for example, include one or more of a color, a logo, a design, an emblem, a seal, a pattern, a word, a symbol, a photograph, or another form of ornamental marking. In certain embodiments, the second set of ornamental markings may convey to viewers information relating to the sport or recreational activity that will be performed using the equipment, the date and/or time of the second event, and/or the name of the second event. In certain embodiments, the second set of ornamental markings may convey to viewers information relating to the host of the second event, a sponsor of the second event, a beneficiary of the second event, and/or a participant in the second event. The second embellishment procured in block 442 may further comprise a second set of functional markings, such as the boundary lines and/or target zones described above. In certain embodiments, the second embellishment may include the same or similar functional markings as those included in the first embellishment.

Block 440 further includes block 444, which generally involves removably adhering the second embellishment to the planar surface of the equipment. Block 444 is substantially similar to block 424, and the details thereof need not be repeated herein.

The process 400 further includes block 450, which generally involves providing the equipment with the second embellishment attached to a second party. The second party may, for example, be an organizer of the second event, a host of the second event, a participant in the second event, a sponsor of the second event, a beneficiary of the second event, or a party acting on behalf of the organizer, host, participant, sponsor, and/or beneficiary. In certain embodiments, the second party may be the same as the first party, while in other embodiments, the second party may be different from the first party. Block 450 is substantially similar to block 430, which is described above.

Block 450 includes block 452, which generally involves delivering constructive or actual possession of the equipment to the second party. For example, block 452 may involve delivering possession of the equipment to the second party in a manner analogous to that described above with reference to block 432.

In certain embodiments, block 450 includes block 454, which generally involves hosting the second event. For example, should the equipment be permanently installed to a premises that is in the possession of the party performing the process 400, such a party may host the second event or allow the second event to be hosted on the premises.

Block 450 further includes block 456, which generally involves accepting receipt of the equipment, for example after conclusion of the second event. For example, block 454 may involve accepting receipt of the equipment from the second party in a manner analogous to that described above with reference to block 436.

As should be appreciated, blocks 440 and 450 may be repeated as desired to preparing the sports or recreational equipment for use in additional events and to provide the equipment with a corresponding embellishment attached to a party connected with the additional event.

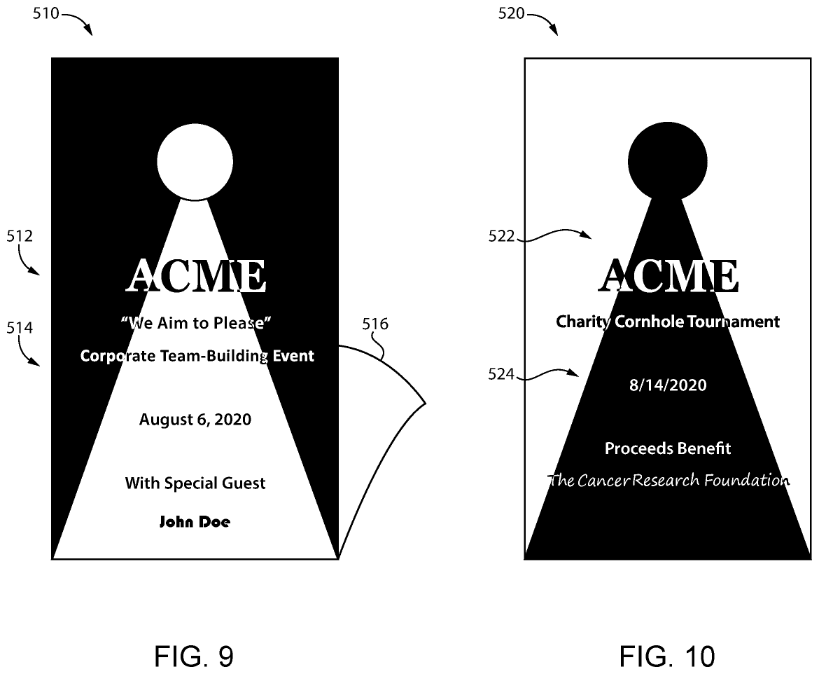

With additional reference to FIGS. 9 and 10, an example use case of the process 400 will now be described. It should be appreciated that the example use case is provided for purposes of illustration only, and should not be construed as limiting the scope of the subject matter disclosed herein.

In block 410, an event organizing service procures a plurality of cornhole boards 310, for example by purchasing or building the cornhole boards 310. The organizing service is contracted by client Acme to facilitate a team-building event in which the client will provide cornhole boards for the amusement of their employees. The organizing service is also contracted by a local charity to facilitate a charity cornhole tournament that is to be sponsored by Acme.

In block 420, the organizing service prepares the cornhole boards 310 for use at the first event. More particularly, in block 422, the service procures a plurality of first embellishments 510, for example by ordering the first embellishments 510 or printing the first embellishments 510 on a sheet of vinyl having an adhesive backing. Knowing that the charity event will be held shortly after the team-building event, the organizing service also performs block 442 and procures a plurality of second embellishments 520.

The first embellishments 510 have approximately the same dimensions as the playing surface 312 of the boards 310, and include ornamental markings 512 and functional markings 514. The ornamental markings 512 include the name of the client hosting the event, the motto of the client, the name of the event, the date of the event, and the name of a special guest who will be participating in the event. The functional markings 514 are shaped to provide a target zone for participants, and are provided in the client's company colors. Thus, the ornamental markings 512 are also functional, and the functional markings 514 are also ornamental. The design for the first embellishments 510 may be generated in-house by the organizing service, or may be provided by the client or another party.

Like the first embellishments 510, the second embellishments 520 have approximately the same dimensions as the playing surface 312 of the boards 310, and include ornamental markings 522 and functional markings 524. The ornamental markings 522 include the name of the sponsor of the event, the type of the event, the date of the event, and an indication regarding the beneficiary of the event. The functional markings 524 are shaped to provide a target zone for participants, and are provided in the charity's standard colors. Thus, the ornamental markings 522 are also functional, and the functional markings 524 are also ornamental. The design for the second embellishments 520 may be generated in-house by the organizing service, or may be provided by the client or another party.

In block 424, the organizing service applies the first embellishments 510 to the plurality of cornhole boards 310. More particularly, the organizing service removes the protective film 516 from the rear side of the embellishments 510 to expose the adhesive, and applies each embellishment 510 to a corresponding board 310 without applying an additional adhesive medium (e.g., water) to either of the embellishment 510 or the playing surface 312. The first embellishments 510 are sized and shaped such that when applied to the playing surfaces 312, the embellishments 510 cover the substantial entirety of the playing surfaces 312.

In block 430, the organizing service temporarily provides to the client the cornhole boards 310 with the first embellishments 510 attached thereto. More particularly, in block 432, the organizing service delivers the embellished boards 310 to the locus of the event, which is being held at the client's place of business. With the client hosting the event, block 434 is not performed by the service, and is instead performed by the client. After the conclusion of the event, the service returns to the locus of the event and retrieves the boards in block 436, and returns the boards to the service's place of business or an associated warehouse or staging area.

Upon returning to the service's place of business or associated warehouse or staging area, the service performs block 440 to prepare the boards 310 for the charity event. In block 441, the service removes the first embellishments 510 from the boards 310 without damaging the playing surfaces 312 of the boards 310 and without leaving a residue on the playing surface 312. As a result, the boards 310 remain capable of being used even when no embellishment is mounted thereon. With the first embellishments 510 removed and the second embellishments 520 previously procured, the service proceeds to block 444, in which the service applies the second embellishments 520 to the playing surfaces 312 of the boards 310 in a manner similar to that in which the first embellishments 510 were applied to the boards 310 in block 424.

In block 450, the service temporarily provides the boards 310 including the second embellishments 520 for use in the charity tournament. More particularly, in block 452, the service delivers the embellished boards 310 from the warehouse or staging area to an event center that is owned by the service. The charity has reserved a portion of the event center for the occasion such that the charity receives constructive possession of the embellished boards 310 upon commencement of the event. In block 454, the organizing service hosts the charity event by providing food and beverages at the portion of the event center reserved for the charity. Upon completion of the tournament, the service regains possession of the embellished boards 310 in block 456. The service may then repeat blocks 440 and 450 as desired to provide embellished cornhole boards 310 for other events.

While the process 400 has generally been described with reference to FIG. 8 and an example use case of the process 400 has been described with reference to FIGS. 8-10, it is to be appreciated that additional and alternative embodiments of the process 400 are contemplated as within the scope of the subject matter described herein. For example, the organizing service or another entity may perform an embodiment of the process 400 in which table tennis table embellishments 220 are selectively and adhered to and removed from one or more table tennis tables 320. As another example, the organizing service or another entity may perform an embodiment of the process 400 in which pickleball paddle embellishments 230, 240, 250 are selectively and adhered to and removed from one or more pickleball paddles 330, 340, 350. As a further example, the organizing service or another entity may perform an embodiment of the process 400 in which shuffleboard table embellishments 260 are selectively and adhered to and removed from one or more shuffleboard tables 360. As yet a further example, the organizing service or another entity may perform an embodiment of the process 400 in which table tennis paddle embellishments 270 are selectively and adhered to and removed from table tennis paddles 370. As another example, the organizing service or another entity may perform an embodiment of the process 400 in which foosball table embellishments are selectively and adhered to and removed from foosball tables.

While the invention has been illustrated and described in detail in the drawings and foregoing description, the same is to be considered as illustrative and not restrictive in character, it being understood that only the preferred embodiments have been shown and described and that all changes and modifications that come within the spirit of the inventions are desired to be protected.

It should be understood that while the use of words such as preferable, preferably, preferred or more preferred utilized in the description above indicate that the feature so described may be more desirable, it nonetheless may not be necessary and embodiments lacking the same may be contemplated as within the scope of the invention, the scope being defined by the claims that follow. In reading the claims, it is intended that when words such as “a,” “an,” “at least one,” or “at least one portion” are used there is no intention to limit the claim to only one item unless specifically stated to the contrary in the claim. When the language “at least a portion” and/or “a portion” is used the item can include a portion and/or the entire item unless specifically stated to the contrary.

What is claimed is:

1. An embellishment for use with sports or recreational equipment having a planar surface, the embellishment comprising:
a planar sheet including a front surface and a rear surface opposite the front surface, wherein the planar sheet is sized and shaped to correspond to a size and shape of the planar surface of the equipment;
wherein the front surface of the planar sheet comprises at least one ornamental marking and/or at least one functional marking, each functional marking relating to performance of a sport or recreational activity corresponding to the equipment; and
wherein the rear surface of the planar sheet has disposed thereon an adhesive configured to removably secure the planar sheet to the planar surface.

2. The embellishment of claim 1, wherein the at least one functional marking comprises at least one of a boundary line and a target area.

3. The embellishment of claim 1, wherein the at least one ornamental marking comprises one or more of a logo, a design, an emblem, a seal, a pattern, a word, a symbol, and a photograph.

4. The embellishment of claim 1, wherein the rear surface further comprises an additional ornamental marking.

5. The embellishment of claim 1, further comprising a protective film adhered to the rear surface, wherein removal of the protective film exposes the adhesive.

6. The embellishment of claim 1, wherein the adhesive is configured such that removal of the embellishment from the planar surface does not damage the planar surface and does not leave a residue on the planar surface.

7. A system, comprising:
sports or recreational equipment comprising a planar surface; and
an embellishment removably attached to the planar surface, the embellishment comprising ornamental markings and an adhesive by which the embellishment is removably attached to the planar surface, wherein the adhesive is configured to enable removal of the embellishment from the planar surface without damaging the planar surface and without leaving a residue on the planar surface.

8. The system of claim 7, wherein the sports or recreational equipment is configured for use in a particular sport or recreational activity; and
wherein the embellishment further comprises a functional marking relating to performance of the particular sport or recreational activity.

9. The system of claim 8, wherein the functional marking comprises at least one of a target zone or a boundary line.

10. The system of claim 7, wherein the embellishment covers at least 90% of the planar surface.

11. The system of claim 7, wherein the embellishment covers at least 98% of the planar surface.

12. The system of claim 7, wherein the embellishment comprises a vinyl sheet having a first surface and an opposite second surface;
wherein the ornamental markings are disposed on the first surface; and
wherein the adhesive is disposed on the opposite second surface.

13. The system of claim 7, wherein the equipment comprises one of:
a cornhole board wherein the planar surface is defined by a playing surface of the cornhole board;
a table tennis table wherein the planar surface is defined by a playing surface of the table tennis table;
a shuffleboard table wherein the planar surface is defined by a playing surface of the shuffleboard table; and
a basketball goal wherein the planar surface is defined by a backboard of the basketball goal.

14. The system of claim 7, wherein the equipment comprises one of:
a table tennis paddle wherein the planar surface is defined by a striking surface of the table tennis paddle; and
a pickleball paddle wherein the planar surface is defined by a striking surface of the pickleball paddle.

15. A method, comprising:
removably adhering a first embellishment to a planar surface of sports or recreational equipment, the first embellishment comprising a first ornamental marking relating to a first event involving use of the equipment, wherein the equipment with the first embellishment attached thereto is utilized in the first event;
removing the first embellishment from the planar surface; and
removably adhering a second embellishment to the planar surface, the second embellishment comprising a second ornamental marking relating to a second event involving use of the equipment, wherein the equipment with the second embellishment attached thereto is utilized in the second event.

16. The method of claim 15, wherein the first ornamental marking is different from the second ornamental marking.

17. The method of claim 15, wherein the first ornamental marking conveys to a viewer information relating to at least one of:
a date and/or time of the first event;
the sport or recreational activity;
a name of the first event;
a host of the first event;
a sponsor of the first event;
a beneficiary of the first event; and
a participant in the first event.

18. The method of claim 15, wherein the first embellishment further comprises a functional marking relating to performance of the sport or recreational activity.

19. The method of claim 18, wherein the second embellishment further comprises the functional marking.

20. The method of claim 15, wherein the first embellishment comprises a front surface including the first ornamental marking and a rear surface comprising an adhesive by which the first embellishment is removably adhered to the planar surface;
wherein the planar surface is transparent or translucent; and
wherein the rear surface of the first embellishment further comprises additional ornamental markings.

21. The method of claim 20, wherein removably adhering the first embellishment to the planar surface comprises:
removing a protective film from the rear surface of the first embellishment, thereby exposing the adhesive; and
directly applying the rear surface to the planar surface without the use of an additional adhesive medium.

22. The method of claim 15, wherein the equipment comprises one of:
a basketball goal, wherein the planar surface is defined by a backboard of the basketball goal;
a cornhole board, wherein the planar surface is defined by a playing surface of the cornhole board;
a table tennis paddle, wherein the planar surface is defined by a striking surface of the table tennis paddle;
a table tennis table, wherein the planar surface is defined by a playing surface of the table tennis table;
a pickleball paddle, wherein the planar surface is defined by a striking surface of the pickleball paddle; and
a shuffleboard table, wherein the planar surface is defined by a playing surface of the shuffleboard table.

23. The method of claim 15, wherein each of the first embellishment and the second embellishment, when applied to the planar surface, covers at least 75% of the planar surface.

24. The method of claim 15, wherein each of the first embellishment and the second embellishment, when applied to the planar surface, covers an entirety of the planar surface.

25. The method of claim 15, further comprising:
subsequent to removably adhering the first embellishment to the planar surface, providing the equipment with the first embellishment attached to a first party;
subsequent to the first event, accepting receipt of the equipment from the first party, wherein removing the first embellishment from the planar surface is performed subsequent to accepting receipt of the equipment from the first party; and
subsequent to removably adhering the second embellishment to the planar surface, providing the equipment with the second embellishment attached to a second party.
